(19) United States
(12) Patent Application Publication
(10) Pub. No.: US 2003/0104899 A1
(43) Pub. Date: Jun. 5, 2003

(54) Steerable vehicle having a multiple-power unit controller and a method of controlling power to an electric motor

(76) Inventor: Jesse P. Keller, San Diego, CA (US)

Correspondence Address: LYON & LYON LLP, 633 WEST FIFTH STREET, SUITE 4700, LOS ANGELES, CA, 90071, US

(21) Appl. No.: 10/006,996

(22) Filed: Nov. 30, 2001

(51) Int. Cl. B60K 5/08

(52) U.S. Cl. 477/2; 180/65.2; 180/65.3

(57) ABSTRACT

A steerable vehicle that includes a drive train that is used to propel the vehicle. The steerable vehicle comprises a plurality of auxiliary power units (APUs), an electric motor, and a power controller. The APUs are operatively isolated from the drive train and electrically coupled to the electric motor to provide power to the electric motor. The electric motor is mechanically coupled to the drive train to propel the vehicle. The power controller is communicably coupled to the APUs and to the electric motor. The power controller monitors the status of the components of the vehicle to determine the power requirements of the vehicle. Each APU is associated with an efficiency profile. The power controller utilizes the efficiency profiles to control the APUs and provide power to the electric motor as efficiently as possible.

### BACKGROUND OF THE INVENTION

1. Field of the Invention

The field of the present invention is hybrid vehicles, and in particular hybrid vehicles having multiple power units that provide power to an electric motor, the electric motor providing the mechanical power that propels the vehicle.

2. Background

Presently, two general types of hybrid vehicles are designed and manufactured. The first type of hybrid vehicle typically includes a combustion engine and one or more electric motors coupled in parallel such that the engine and the motors both mechanically propel the vehicle. Present designs that use multiple combustion engines mechanically couple the engines and require that the engine speeds be controlled or a clutch used to provide smooth engagement or disengagement of the engines at the point of mechanical coupling. The mechanical coupling itself and the need to control engine speeds, however, results in complexities being introduced into the system.

The second type of hybrid vehicle typically includes a combustion engine and one or more electric motors coupled serially such that the engine provides electric energy to the motors and the motors propel the vehicle. U.S. Pat. No. 5,359,228 discloses an example of a serial hybrid vehicle and the control of the engine and motor. In the typical serial hybrid vehicle, the engine is a combustion engine that is mechanically coupled to a generator to generate electric energy. The electric energy is supplied to the electric motor and/or to one or more energy storage subsystems that store the electric energy for later use. In generating the electric energy, the engine generates an appropriate level of power according to the needs of the energy storage subsystems and the electric motor.

The combustion engine, electric motor, and batteries in a serial hybrid vehicle are sized according to the acceleration requirements of the vehicle's operating conditions. High accelerations place the greatest power demands on the vehicle's systems. In most vehicles, however, high accelerations are usually needed only during a small percentage of the vehicle's operational time. None the less, a vehicle's systems are typically designed to meet the vehicle's most demanding acceleration needs. During those times that high accelerations are not needed, much of the capacity of the vehicle's systems remain unused. The unused excess capacity results in the engine inefficiently using fuel and in the release of additional emissions. Such results run contrary to two primary goals of hybrid vehicles, namely efficient fuel use and reduced emissions.

### SUMMARY OF THE INVENTION

The present invention is directed to a steerable vehicle having a plurality of auxiliary power units (APUs), an electric motor, and a power controller. The plurality of auxiliary power units generate electric energy that is supplied to the electric motor. The electric motor is mechanically coupled to the drive train of the vehicle to propel the vehicle. The power controller monitors the statuses of the aforementioned components and of other operational aspects of the vehicle. Based upon the monitored statuses, the power controller provides the electric motor with power from one or more of the plurality of auxiliary power units.

Thus, in a first separate aspect of the present invention, a steerable vehicle having a drive train to propel the vehicle comprises a plurality of auxiliary power units, an electric motor, and a power controller. The plurality of APUs are operationally isolated from the drive train of the vehicle and electronically coupled to the electric motor. Thus, the electric motor obtains power from one or more of the APUs. The power controller is communicably coupled to the plurality of APUs, to the electric motor, and to other operational aspects of the vehicle to monitor the statuses of the same. Based upon the monitored statuses, the controller determines when to activate one or more of the APUs to provide power to the electric motor. The controller determines which of the APUs to activate by referencing efficiency profiles of the APUs.

In a second separate aspect of the present invention, an energy storage subsystem is electronically coupled to the APUs and to the electric motor. The energy storage subsystem may comprise one or more batteries, one or more ultra capacitors, one or more flywheels, or any combination thereof. The energy storage subsystem stores power that may be used to power the electric motor. The power controller is also communicably coupled to the energy storage subsystem to monitor the status of the energy storage subsystem. The power controller may provide power to the electric motor from the energy storage subsystem, from one or more of the APUs, or from a combination thereof. When the energy storage subsystem has less than a full capacity of power, the subsystem may be charged with power from the APUs.

In a third separate aspect of the present invention, a first APU has a first efficiency profile and a second APU has a second efficiency profile that is different from the first efficiency profile. By having APUs that have different efficiency profiles, the power may be supplied by the APU that can best meet the power requirements of the vehicle while operating in a region of relative efficiency, as determined by the efficiency profiles.

In a fourth separate aspect of the present invention, at least one of the APUs comprises an engine mechanically coupled to a generator. The generator is electrically coupled to and provides power to the electric motor. The engine may be a combustion engine.

In a fifth separate embodiment of the present invention, any of the foregoing aspects may be employed in combination.

Accordingly, it is an object of the present invention to provide a power controller for a steerable vehicle with electric motor and multiple power units that provide power to the electric motor. Other objects and advantages will appear hereinafter.

### BRIEF DESCRIPTION OF THE DRAWINGS

In the drawings, wherein like reference numerals refer to similar components:

FIG. 1 is a block diagram that illustrates a steerable vehicle with multiple auxiliary power units and a power controller in accordance with an embodiment of the present invention;

FIGS. 2A and 2B together illustrate a circuit schematic of a dual-engine power controller in accordance with an embodiment of the present invention;

FIG. 3 is a flow diagram showing an overview of the engine control process for a power controller in accordance with an embodiment of the present invention;

FIG. 4 is a flow diagram showing the process used by a power controller to start up an engine in accordance with an embodiment of the present invention;

FIG. 5 is a flow diagram showing the process used by a power controller to manage the power output of multiple operating engines in accordance with an embodiment of the present invention;

FIG. 6 is a flow diagram showing the process used by a power controller to determine whether an additional available engine should be activated in accordance with an embodiment of the present invention;

FIG. 7 is a flow diagram showing the process used by a power controller to determine whether an engine in use should be deactivated in accordance with an embodiment of the present invention; and

FIG. 8 is a flow diagram showing the process used by a power controller to manage detected faults relating to an engine in accordance with an embodiment of the present invention.

### DETAILED DESCRIPTION OF THE PREFERRED EMBODIMENTS

Turning in detail to the drawings, FIG. 1 illustrates a block diagram of a steerable hybrid vehicle in accordance with one embodiment of the present invention. The hybrid vehicle 10 includes an AC electric motor 12 that is mechanically coupled to the drive train 14. The drive train 14 is used to propel the vehicle 10. The electric motor 12 is electrically coupled to a power inverter 18 through which the AC electric motor 12 receives electric power. Alternatively, a DC electric motor may be used in place of the AC electric motor 12 and the power inverter 18. However, an AC motor is preferred for heavier vehicles because AC motors generally provide more power and tend to have longer operational life spans. A plurality of auxiliary power units (APUs) 16(1)-(n) and one or more batteries 15 are electrically coupled to the power inverter 18 via a DC bus 17. The batteries are the energy storage subsystem for the vehicle of FIG. 1. Alternatively, the energy storage subsystem may comprise one or more ultra capacitors, one or more flywheels, or any combination of appropriate energy storage systems.

The APUs 16(1)-(n) and the batteries 15 supply DC power to the power inverter 18, which converts the supplied DC power to AC power for use by the electric motor 12. The batteries 15 may be charged either from power provided by the APUs 16(1)-(n) or from power generated through regenerative feedback from the electric motor 12 during deceleration. In an alternative embodiment, the energy storage subsystems are excluded from the vehicle and the electric motor is powered solely from the APUs.

A power controller 30 is communicably coupled to each APU 16(1)-(n), the electric motor 12, the power inverter 18, the fuel tank 26, the batteries 15, and to various other operational aspects (not shown) of the hybrid vehicle. The other operational aspects of the hybrid vehicle may include, but are not limited to, a starter key position, an emergency ‘OFF’ switch or button, a reset switch or button, an accelerator command provided by the driver or a vehicle on-board electric drive system, a brake pressure, an operating temperature of any component, a steering direction of the hybrid vehicle, a fuel flow from the fuel tank to the APUs, and power requirements of any accessories that draw electric energy from the APUs or batteries. The power controller 30 is also communicably coupled to various driver feedback indicators (not shown), such as an on/off indicator, one or more fault indicators, a fuel level, and a battery charge level. The method of communicably coupling the various components of the hybrid vehicle to the processor 32 may be accomplished by direct electrical connections between the components and the processor 32, by the inclusion of one or more data buses to which the components are connected, wherein the processor may separately identify each component connected to the data bus, or by a combination of the two methods. In FIG. 1, the power controller 30 is shown having two separate vehicle control busses, an APU controller bus 36 and a vehicle control data bus 38, and a plurality of direct electrical connections 40 that monitor driver controls and control driver indicators with discrete electronic signals.

The power controller 30 in FIG. 1 comprises a processor 32 and a memory 34. The processor 32 and memory 34 may be any appropriate type known to those skilled in the art. The processor 32 operates in accordance with programming to control the operation of each APU 16(1)-(n). The processor 32 thus controls the power supplied to the batteries 15 and to the power inverter 16. The control programming may be embedded within the circuitry of the processor 32, or alternatively, the processor 32 may load and run the control programs from the memory 34. For processors that load and run the control programs, the control programs are stored within the memory 34. Regardless of where the control programming resides, information used by the power controller 30 to operate the hybrid vehicle, such as engine efficiency profiles, the status of various vehicle components, and other similar information discussed herein, are stored in the memory 34. The memory 34 may also store data collected by the power controller 30 during vehicle operation, such as operational and maintenance history of the vehicle. The power controller 30 includes a standardized computer interface (not shown), such as a controller area network (CAN) interface, an RS-232 interface, a USB interface, or any other appropriate computer interface. Through the computer interface, any computer with the appropriate software and interface hardware may connect to the power controller 30 to read or write information to the memory 34, such information including control programs, data used by the control programs, and data gathered by the power controller 30 during vehicle operation.

The power controller 30 may monitor the power requirements of the vehicle directly, by monitoring the power requirements of each power consuming component of the vehicle, or indirectly by monitoring the voltage on the DC bus. When monitoring the voltage on the DC bus, those skilled in the art will recognize that a drop in voltage indicates an increase in power demanded by one or more components of the vehicle. Based on the power requirements, the power controller 30 may activate one or more of the APUs as needed. Once an APU has been activated, the power controller 30 may operate the APU in an appropriate manner to meet the power requirements of the vehicle, or operate the engine to exceed the power requirements of the vehicle and simultaneously charge the batteries.

The power controller 30 may also monitor the overall health of the batteries. Battery monitoring may be advantageous in that weak batteries may be identified and replaced prior to actual failure. Additionally, the power controller may include additional status information about the batteries when determining the power requirements of the vehicle. By including detailed information about the batteries, the power controller 30 may optimize battery performance and extend the useful life-span of the batteries.

Each APU 16(1)-(n) in FIG. 1 comprises an APU controller 20, an engine 22, and a generator 24. The engine 22 is mechanically coupled to the generator 24 such that, when the engine 22 is activated, the generator 24 is provided with mechanical power that it converts into electrical energy. The generated electrical energy is provided to the electric motor and/or the batteries. Alternatively, the APUs may comprise a turbine, a fuel cell, or any other type of electric energy generator that may be incorporated into a vehicle. Each APU may also comprise a different type of electric energy generator. For example, a first APU may comprise an engine and a generator and a second APU may comprise a fuel cell.

A single fuel tank 26 is appropriately coupled to the APUs 16(a)-(n) to provide each engine 22 with fuel. Alternatively, each engine may have its own separate fuel tank. Such an arrangement may be desirable if different APUs require different types of fuel to operate.

The APU controller 20 is coupled to the engine 22 and to the generator 24 to monitor and control the engine 22 and generator 24. The APU controller 20 is also communicably coupled to the power controller 30. The power controller 30 provides instructions to the APU controller 20 for controlling the engine 22. Thus, the APU controller 20 activates and deactivates the engine 22 and adjusts the engine throttle based on control commands issued by the power controller 30.

The APU controller 20 also provides feedback to the power controller 30 on the status of the engine 22 and the generator 24. The feedback allows the power controller 30 to evaluate the overall health of the engine 22 and generator 24 and make appropriate adjustments to the manner in which power is provided to the electric motor based upon the status of each engine 22. Aspects of the engine 22 that are monitored include exhaust emissions, fuel consumption, and temperature. The mechanical power input into the generator and the electrical energy produced by the generator may be monitored to determine the power conversion efficiency of the generator. Declines in a generator's power conversion efficiency are often indicative of the generator's failing health.

The engine and/or generator types included in each APU may be similar or completely different from those in other APUs. The actual specifications of the engines and generators used depends upon the type of hybrid vehicle (i.e., car, SUV, bus, etc.) and any performance requirements that may need to be met. The APUs may also comprise other means of generating electricity, such as fuel cells, turbines, and any other appropriate generating means that is sufficiently mobile, thus permitting incorporation into a vehicle.

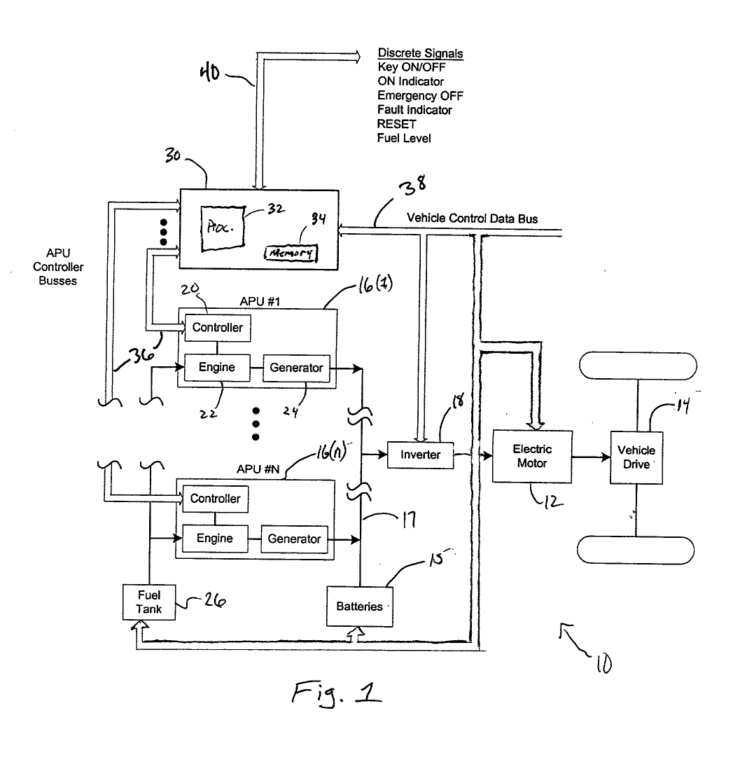

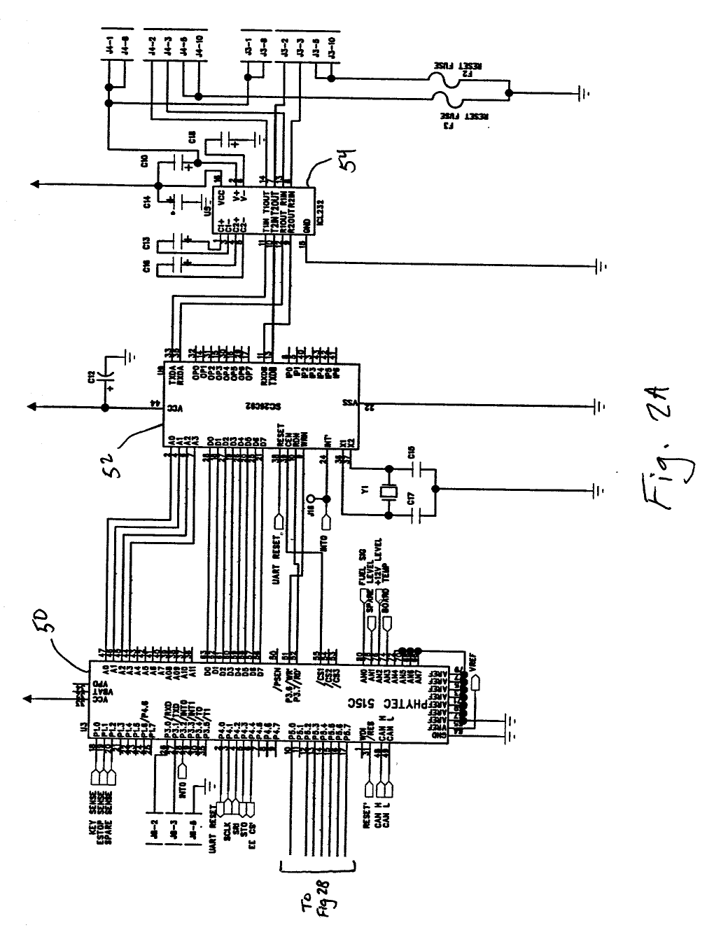

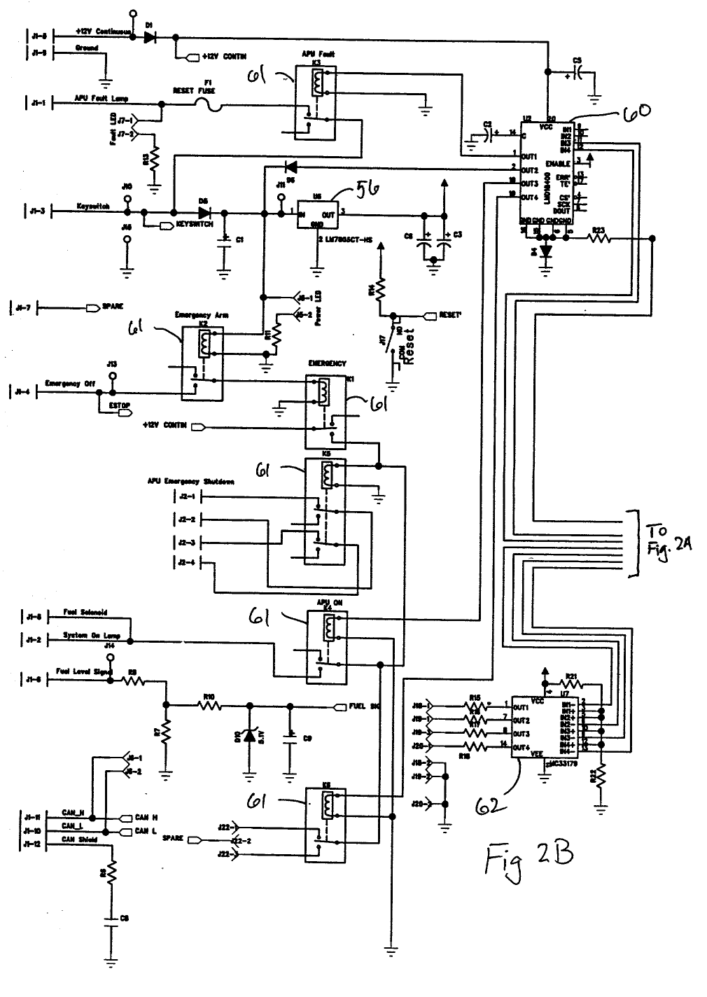

An embodiment of a circuit for a power controller is illustrated in FIGS. 2A and 2B. The command summary and parameter list provided in Appendix A may be utilized with the power controller of FIGS. 2A and 2B and two microturbines, such as the microturbines manufactured by Capstone Microturbine Corporation of Chatsworth, Calif. The portion of the power controller circuit in FIG. 2A comprises a processor and memory that are included on a daughter-board module 50. The daughter-board module 50 illustrated is model kitCON-515C, manufactured by Phytec America LLC of Bainbridge Island, Wash. In addition to the processor and memory, this daughter-board module 50 provides the power controller with a CAN interface that may be used as described above. The power controller also includes a universal asynchronous receiver transmitter (UART) IC 52 that enables the daughter-board module to simultaneously control two engines. Additional UART ICs may be added to control additional engines. A voltage converter 54 is included to convert between the voltage used by the power controller (5 Volts) and the standard voltage used in a vehicle (±12 Volts). The portion of the power controller circuit in FIG. 2B comprises a second voltage converter 56, a signal converter 60 that converts a digital signal into a signal appropriate to operate various relays 61, and an LED driver 62 that provides power to driver indicator LEDs.

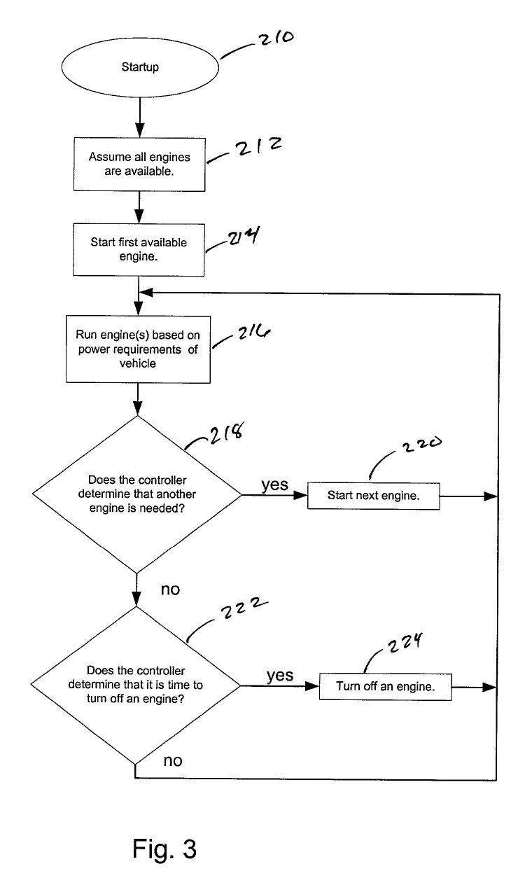

A flow chart of the operational logic of the power controller in one embodiment of the invention is illustrated in FIG. 3. In the description of the processes that follow, the energy storage subsystem is assumed to be one or more batteries. However, those skilled in the art will recognize that little change is required to the following processes if the energy storage subsystem comprises one or more ultra-capacitors or a combination of ultra-capacitors and batteries. After the initial power up sequence (step 210), all engines are assumed functional and available (step 212) to assist in the production of electric energy. After powering up, a first engine is activated (step 214) and the associated generator provides electric energy to the vehicle. The controller operates the first engine (step 216) to generate electric energy, adjusting the first engine's speed appropriately so that the combination of generated power and battery-supplied power meet the power requirements of the vehicle. If at any subsequent time the controller determines that additional power (step 218) is needed to meet the power requirements of the vehicle, then the controller begins the startup-sequence for an additional engine (step 220). Also, if at any subsequent time the controller determines that the power supplied by the active engine or engines exceeds the power requirements of the vehicle (step 222) to the extent that one or more of the active engines may be deactivated, then the controller deactivates one or more of the active engines (step 224). In determining which engine should be deactivated, the controller may consider several factors, including the length of time each engine has been active, the efficiency profiles of all active engines, and the power requirements of the vehicle. The above process of operating the engines based on the power requirements of the vehicle, determining when to activate additional engines, and determining when to deactivate active engines is repeated continuously while the vehicle is in operation.

When activating an additional engine, any engine that is currently inactive and available may be activated. The particular engine activated is chosen based upon the power requirements of the vehicle and the power output capabilities of the available engines. In particular, the efficiency profiles of the available engines are utilized to select the engine that can most efficiently meet the additional power requirements of the vehicle. Other factors may also be considered in combination with the efficiency profiles to select the appropriate engine to activate. The other factors may include, but are not limited to, the recent operation history of the engine, the desired acceleration performance of the vehicle, and factors affecting the energy storage subsystem such as battery conditioning, battery life, and ultra-capacitor charge state.

An engine's efficiency profile is determined in advance of vehicle operation, and is preferably developed for each engine and generator pair. In developing the efficiency profile for an engine and generator pair, the engine is operated to provide various distinct power output levels from the generator. At each distinct power output level, corresponding engine parameters are measured. These parameters preferably include at least the fuel consumption rate and the emissions rate of undesirable exhaust gases. Additional parameters may be included as desired or needed. An engine's efficiency profile is thus a chart or array of the power output level with the associated values of the measured parameters. Within each efficiency profile, one or more operational ranges may be identified at which the engine and generator efficiently provide power based upon a local minimum of either the fuel consumption rate or the emissions rate of the undesirable exhaust gases. For some engines, the local minimums of the two measured rates may approximately coincide, thus providing a preferred range of efficient operation.

Alternatively, efficiency profiles may be developed for the engines without the generators. Such efficiency profiles may be developed by associating the mechanical power provided by the engine with the above indicated measured parameters. When developing an efficiency profile for the engine alone, the engine is preferably operated under a load that is approximately equivalent to the load a generator provides when coupled to the engine.

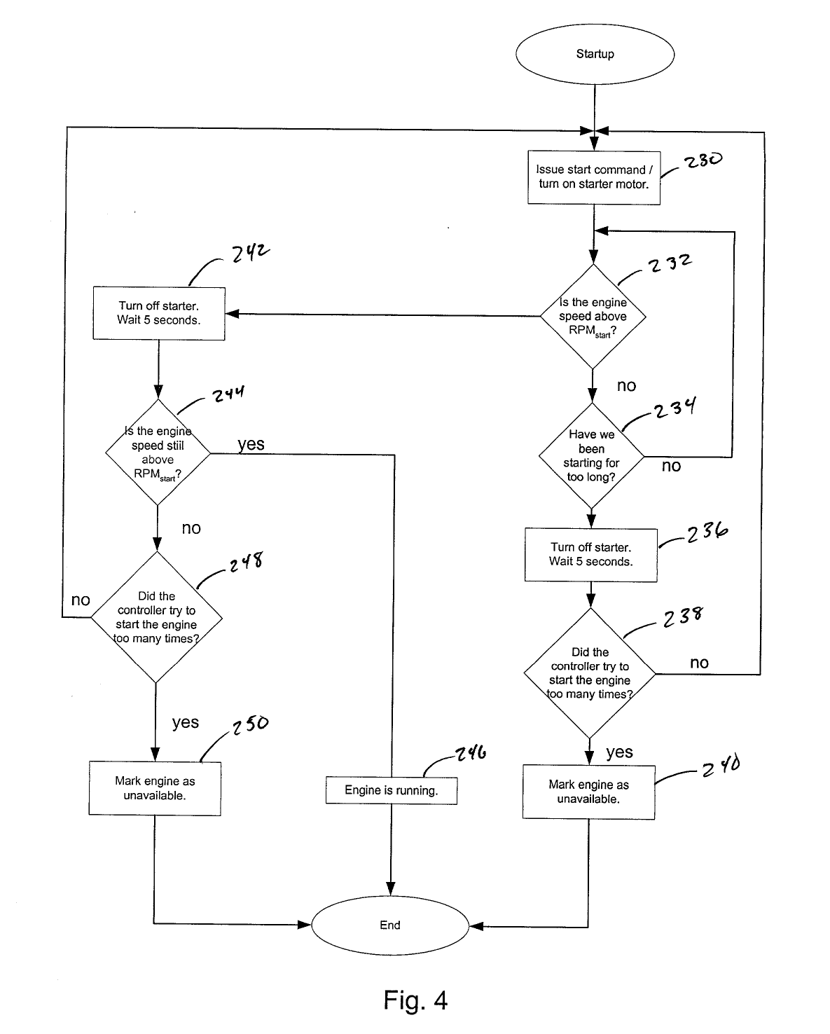

A flow chart of a process that may be used to start an engine is illustrated in FIG. 4. Initially, a command is issued to turn on the engine's starter motor (step 230). The engine is thereafter monitored to determine if the engine speed has exceeded a predetermined rate (step 232), which is preferably less than the idle speed but greater than the speed of the engine when driven by the starter motor. The attempt to start the engine is allowed to continue for a predetermined time period. While the engine speed remains below the predetermined rate, the starting process is continued until the expiration of the time period (step 234). The amount of time allowed to start an engine varies and is frequently dependant upon the type of engine used and the current environmental conditions. For example, a gasoline ignition engine, a diesel engine, and a turbine engine typically all take different amounts of time to start. Therefore, the time period to start a diesel engine should be greater than the time period to start a gas engine.

Once the time period allotted to start the engine has expired, the starter motor is turned off for a short rest period (step 236). This rest period may be as long or as short as desired, but the length should be such that the engine is at least temporarily motionless. The above engine start process is preferably attempted at least twice (step 238). The actual number of times the start process is attempted may be predetermined, or it may be based upon the urgency of the power requirements of the vehicle. Once the limit of attempts to start the engine has been reached, if the engine cannot be started, the engine is marked as unavailable (step 240) and the start process for the engine ends.

If an engine's speed exceeds the predetermined rate, the engine is assumed to have started and the starter motor is turned off (step 242). After the starter motor has been off for a short period, the engine speed is checked against the predetermined rate to verify that the engine is actually running (step 244). An running engine is thereafter identified as such (step 246) and the start process is concluded. If the engine speed is not above the predetermined rate when it is checked (step 248), then the start process may be attempted again. If the maximum number of start attempts is reached and the engine cannot be started, then the engine is marked as unavailable (step 250) and the start process for the engine ends. After ending the start process without success at starting the engine, another engine may be started, if one is available.

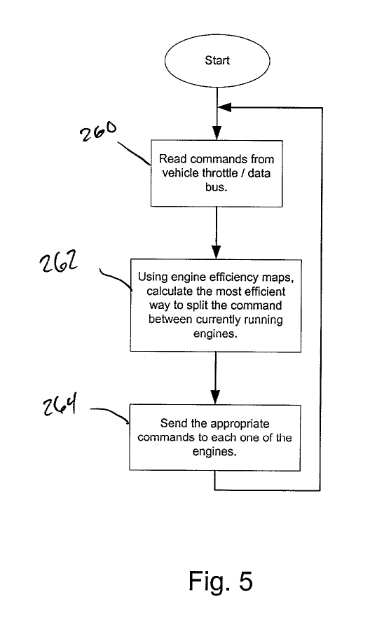

FIG. 5 illustrates a flow chart of a process that may be used to control power output generated by the engines. This process is run continually during operation of the vehicle and does not end until vehicle operation ceases. Following initialization, the power requirements of the vehicle are determined (step 260). After determining the power requirements, the efficiency profiles of all active engines are used to determine how to meet the power requirements of the vehicle while operating the engines as efficiently as possible under the circumstances (step 262). Thereafter, appropriate operational commands are issued to each engine to generate the needed power (step 264).

The following examples demonstrate how one or more engines might be operated to meet the power requirements of a vehicle. In a vehicle that does not include batteries, if only one engine is active, that one engine must meet the power requirements of the vehicle and continue doing so until another engine is activated. Thus, depending on the power requirements of the vehicle in this example, it might not be possible to operate the one engine efficiently. If the same vehicle does include batteries, then power produced by the one engine and from the batteries are combined to meet the power requirements of the vehicle. As another example, in a vehicle with two active engines and no batteries, the power requirements may be met by operating the first engine in its most efficient range and operating the second engine to provide any additional power needed to meet the power requirements. In such a vehicle, those skilled in the art will recognize that it may be advantageous to have two engines with notably different efficiency profiles so that it may be possible to operate both engines within respective efficient ranges.

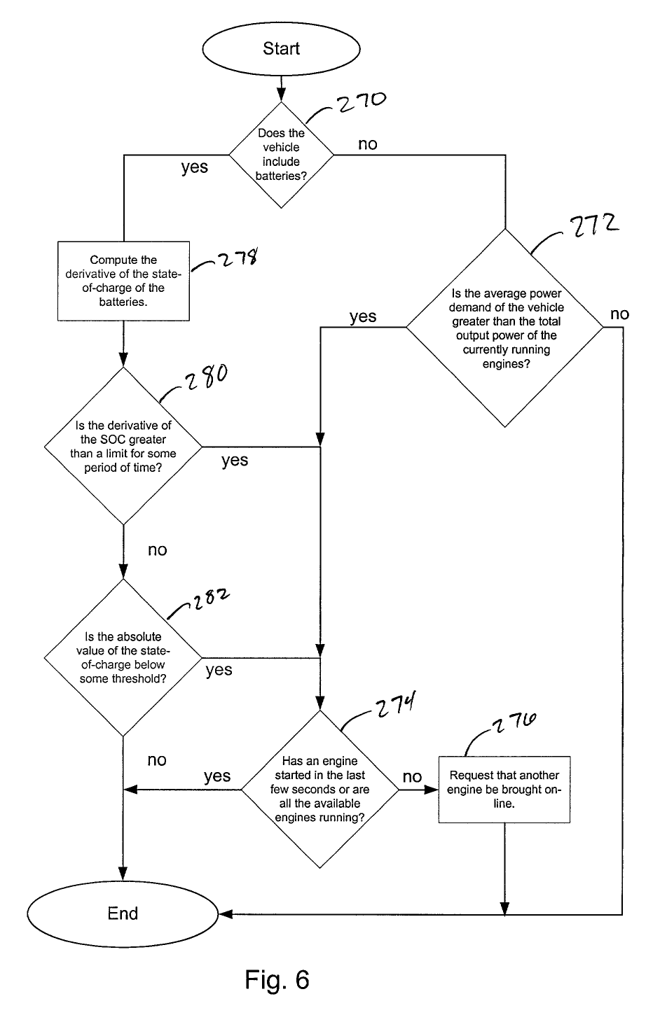

FIG. 6 illustrates a flow chart of a process that may be used to determine when to activate an additional engine. Initially, the process determines whether the vehicle includes batteries that supply power to the electric motor (step 270). In a vehicle that does not include batteries, the average power required by the vehicle is calculated and compared to the total power output capabilities generated by the active engines (step 272). If the average power required is less than the output capabilities generated by the active engines, the process ends. However, if the average power required is greater than the output capabilities generated by the active engines, the process checks whether another engine has recently been started (but is not yet providing power) or whether all available engines are active (step 274). If either of these conditions are true, the process ends. If neither condition is true, the process initiates the engine activation process of FIG. 4 (step 276).

The average power required may be calculated in many different ways, however, the calculation is performed to estimate the future power requirements of the vehicle. Thus, the average is preferably determined over a short period of time immediately preceding the time of the calculation. The actual time period over which the average is taken depends upon the particular vehicle and the conditions under which the vehicle is operated.

In a vehicle that includes batteries, determining whether or not additional power is needed is based upon the charge on the batteries. Initially, the rate at which the batteries are depleting power is calculated (step 278). The rate may be calculated as the derivative of the battery charge over time. The rate for a recent time period is compared to a preset value to determine if the batteries are losing power more quickly than is desirable (step 280). If the rate of batteries power depletion is within acceptable limits, then the charge on the batteries is checked to ensure the charge level is not too depleted (step 282). If the batteries are losing power too quickly or if the charge level is too low, another engine is activated provided that another has not recently been activated and another engine is available. Otherwise, this process will end without activating any additional engines.

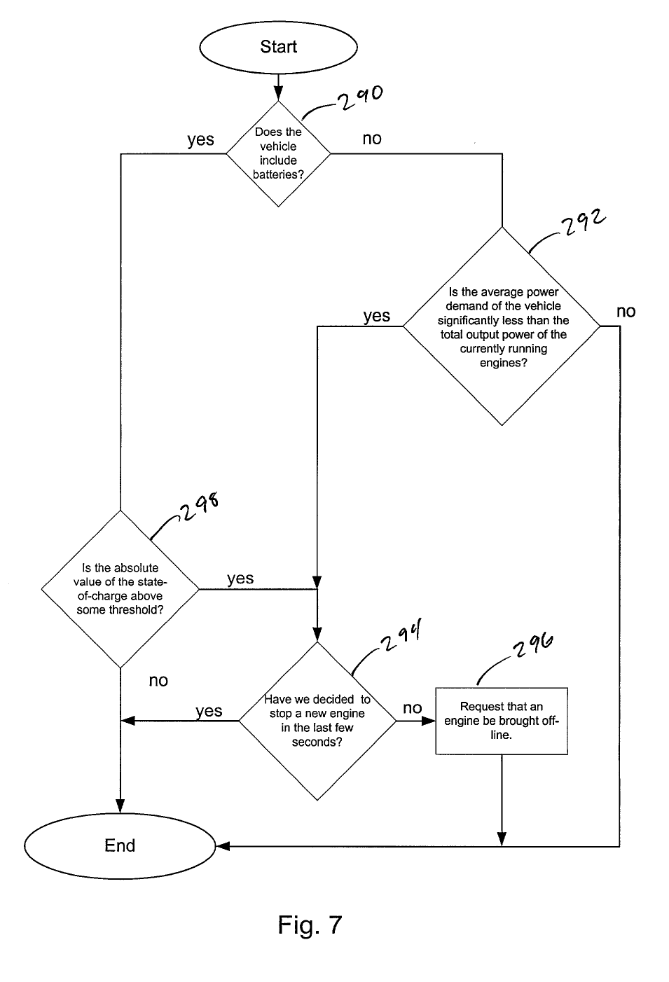

FIG. 7 illustrates a flow chart of a process that may be used to determine when to deactivate an engine. The following description of the engine deactivation process assumes the vehicle has two active engines. Initially, the process determines whether the vehicle includes batteries that supply power to the electric motor (step 290). In a vehicle that does not include batteries, the average power required by the vehicle is calculated and compared to the total output capabilities of the active engines (step 292). If the average power required is not less than the output capability of any one of the active engines, then the process ends. However, if the average power required is less than the output capability of any one of the active engines, then the process checks whether another engine has recently been deactivated (but is still providing power) (step 294). If this condition is true, the process ends. However, if this condition is not met, one of the engines is deactivated (step 296).

In a vehicle that includes batteries, determining whether the engines are generating excess power is based upon the charge on the batteries. The charge on the batteries is checked to determine how close the charge level of the batteries is to maximum capacity (step 298). If the charge level is above the predetermined threshold, one of the engines may be deactivated provided that one of the engines has not recently been deactivated. Otherwise, this process will end without deactivating either of the engines.

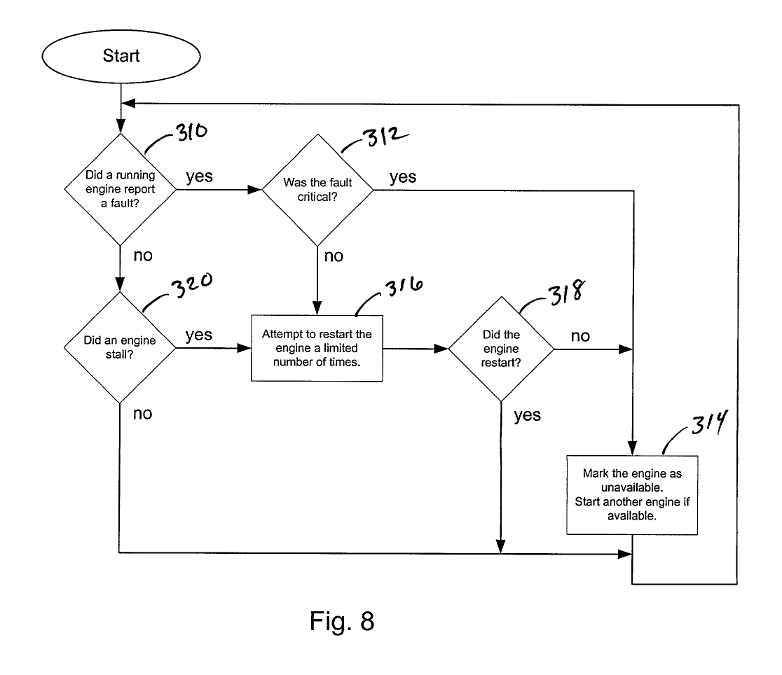

A process that may be used to determine whether an engine is unavailable is illustrated in the flow chart of FIG. 8. This process is repeated continuously while the vehicle is in operation to identify any engine that is no longer properly functioning and mark that engine as unavailable. Once an engine is marked unavailable, the engine activation process may bypass that engine and not waste time repeatedly attempting to activate a faulty engine. This process monitors the active engines for detected faults (step 310). A detected fault is any fault that occurs in an engine system that is actively monitored and detectable. If a fault is detected and the fault is known to prohibit further operation of the engine (step 312), then the engine is marked as unavailable and another engine may be activated (step 314). If the fault is not known to prohibit further operation of the engine, then an attempt is made to restart the engine using the process of FIG. 4 (step 316). Any engine that cannot be restarted (step 318) is marked as unavailable. This process also detects any engine that stalls for an unknown reason (step 320) and attempts to restart the engine (step 316). Again, if a stalled engine cannot be successfully restarted, then that engine is marked as unavailable (step 314) and another engine may be activated.

Thus, a hybrid vehicle having a multiple-power unit controller and a method of controlling multiple power units is disclosed. While embodiments of this invention have been shown and described, it would be apparent to those skilled in the art that many more modifications are possible without departing from the inventive concepts herein. The invention, therefore, is not to be restricted except in the spirit of the following claims.

### Appendix A

The following is a command summary and parameter list that may be used in conjunction with the controller of FIG. 2 and two Capstone microturbines.

### Command Summary

All commands are handled through an RS-232 link. The parameters for communication are 9600 baud, no parity, 1 stop bit, no handshaking. The “Capture Text” function of Windows Hyperterminal or equivalent may be used to record data.

CX—Give a command to turbine X. The command is formatted according to the Capstone Protocol that may be found in the documentation and specifications for Capstone Microturbines.

E—EEPROM

EL followed by “EV LOAD” reloads the parameters from the EEPROM.

ES followed by “EV SAVE” saves the current parameters to the EEPROM.

ED followed by “EV DEF” reloads the system default parameters from the FLASH.

F—Start/Stop the foreground task.

L—Data logging.

LP X=Y Set column X in the data logger output to parameter Y.

LS start/stop the data logging. Starting the data logging prints the parameters it is recording.

P—Parameters

PXXX=Read parameter

PXXX=YYY Set parameter XXX to YYY, if allowed

Q—Quit. If the keyswitch is off, turn off the system self-power circuit.

R—Restart. IMMEDIATELY restart the system. Not recommended with running turbines.

S—Status. Get the status block of the system.

D—Dump. Dump all the parameters to the screen.

U—Initialize UART.

### A. Parameter List

Notes about the parameter list: all entries are WORD (two bytes) in length, the letters in parenthesis indicate the form and/or location where the parameter is stored, wherein “R”=Read capable; “W”=Always writeable; “L”=Writeable only when unlocked; “S”=signed, and “E”=the parameter is stored in the EEPROM.

P00: Software Version (RE) High byte=major; Low Byte=minor.

Examples: 0×105=Rev 1.5 and 0×0314=Rev 3.20.

P01: Hardware Version (RLE) High byte=major; Low Byte=minor.

Examples: 0×0105=Rev 1.5 and 0×0314=Rev 3.20.

P02: Day Compiled (RE) Day of the month=1 . . . 31.

P03: Month Compiled (RE) Month Compiled 1=January; 2=December.

P04: Year Compiled (RE) Years after 1900.

P05: Hour Compiled (RE) 24 hour clock of time compiled.

P06: Minute Compiled (RE) 0-59 minute clock of time compiled.

P07: +12V sensor offset (RWSE) The 12V Reading=(ADC+P07)*P08/100 and the reading is in mV.

P08: +12 V sensor scale factor (RWSE) The 12V Reading=(ADC+P07)*P08/100 and the reading is in mV.

P09: Board Temp offset (RWSE) The board temperature reading=(ADC+P09)*P10/1000 and the reading is in tenths of a degree C.

P10: Board Temp scale (RWSE) The board temperature reading=(ADC+P09)*P10/1000 and the reading is in tenths of a degree C.

P11: Fuel Level offset (RWSE) The fuel level reading=(ADC+P11)*P12/1000 and the reading is in tenths of a percent of full tank.

P12: Fuel Level scale (RWSE) The fuel level reading=(ADC+P11*P12/1000 and the reading is in tenths of a percent of full tank.

P13: Number of turbines (RLE) The number of attached turbines (default=2).

P14: Primary Turbine #(RLE) The primary turbine port number; 1=Primary Turbine attached to Port TURB_{—}1 (default); 2=Primary Turbine attached to Port TURB_{—}2.

P15: Always start primary turbine (RLE)1=TRUE (default); 0=FALSE.

P16: Turb_{—}1 Data Rate (RLE) Baud rate of TURB_{—}1 port; 0=2400; 1=4800; 2=9600; 3=19200 (default); 4=38400; 5=57600

P17: Turb_{—}2 Data Rate (RLE) Baud rate of TURB_{—}2 port; 0=2400; 1=4800; 2=9600; 3=19200 (default); 4=38400; 5=57600

P18: System Mode (RWE) The control mode of the system; 0=Stealth; 1=Full Auto; 2=Primary Turbine On and tracking; 3=Secondary Turbine On and tracking; 4=Both turbines on and tracking. Setting P18 to 0 while either turbine is running will set the power levels to zero, but the turbines will remain running. Set P123 or P143 to zero to stop the turbine.

P19: Positive Gain (single) (RWE) Gain factor when the bus voltage is less than P25 and only one turbine is on-line.

P20: Negative Gain (single) (RWE) Gain factor when the bus voltage is greater than P25 and only one turbine is on-line.

P21: Maximum power increase factor (RWE) The maximum positive delta allowed between the turbine power and the commanded power, in watts.

P22: Maximum power decrease factor (RWE) The maximum negative delta allowed between the turbine power and the commanded power, in watts.

P23: Positive Gain (RWE) Gain factor when the bus voltage is less than P26 and both turbines are on-line.

P24: Negative Gain (RWE) Gain factor when the bus voltage is greater than P26 and both turbines are on-line.

P25: Target voltage (RWE) Target bus voltage when only one turbine is on-line.

P26: Target voltage (RWE) Target bus voltage when both turbines are on-line.

P27: Voltage Hysteresis (RWE) Voltage tracking hysteresis in volts.

P28: Turn on voltage (RWE) Voltage, such that when the system voltage is instantaneously less than P28, the primary turbine starts.

P29: Second turbine trigger voltage (RWE) The second turbine starts when the primary turbine is making more than P30 watts and the voltage is less than P29 for more than P31/10 seconds. P29 is expressed in tenths of a volt.

P30: Second turbine trigger power (RWE) See P29. P30 is expressed in watts.

P31: Second turbine trigger time (RWE) See P29. P31 is expressed in tenths of a second.

P32: Minimum time both turbines run (RWE) The minimum time both turbines run in full power mode.

P33: Reduced power time (RWE) How long the system runs in reduced power mode to see if one turbine is sufficient.

P34: Maximum secondary start cycles allowed (RWE) Maximum number of times the secondary turbine is allowed to start. Otherwise, the turbine will never be turned off.

P35: Fuel on at start (RWE) Turns on the fuel solenoid when the vehicle is started. This is used when the turbine controller power is tied to the fuel solenoid.

P36: Number of e-stops recorded (RE) Records the number of times the e-stop was pressed while the turbine was running.

P37: Number of e-stops for warranty control (RWE) The APU light will flash when P36−P37>5. The APU will not start when P36−P37>10.

P38: Reset when powered—Determines whether the dual turbine controller sends a “REBOOT” command when it is powered up. Setting this to “1” and tying the turbine controller and turbine node power supplies together can cause problems.

P39: Voltage Filter (RWE) Low pass filter value for the system voltage.

P40: Voltage Derivative Filter (RWE) Low pass filter value for the derivative of the system voltage.

P41: Derivative Gain for single turbine operation (RWE) Derivative Gain factor in control loop for single turbine operation.

P42: Derivative Gain for dual turbine operation (RWE) Derivative Gain factor in control loop for dual turbine operation.

P43: Maximum error points (RWE) Maximum number of error “points” upon which the turbine shuts down.

P44: Low voltage alarm trigger on point (RWE) See description of low voltage below.

P45: Low voltage alarm trigger off point (RWE) See description of low voltage below.

P46: Low voltage target (RWE) See description of low voltage below.

P47: Low voltage shutdown gain (RWE) See description of low voltage below.

P48: Low voltage shutdown failure point (RWE) See description of low voltage below.

P100: Board Supply (R) Board supply is measured and expressed in 10 mV units, thus 12.54V=1254.

P101: Board Temperature (R) Degrees C.

P102: System Status (R).

P103: Error bitfield (R).

P110: Turbine 1 Voltage (R) Turbine 1 bus voltage.

P111: Turbine 1 Power (RS) Delivered power in Watts, positive means generated power.

P112: Turbine 1 RPM (R) RPM divided by 10. This parameter is only updated after a ‘status’ command is given.

P113: Turbine 1 Average Temp (R) Average inlet and exhaust temperature. This parameter is only updated after a ‘status’ command is given.

P114: Turbine 1 Power Supply (R) Board supply is measured and expressed in 10 mV units, thus 12.54V=1254. This parameter is only updated after a ‘status’ command is given.

P115: Turbine 1 Liftoffs (R) Number of times the turbine air bearing has lifted off. This parameter is only updated after a ‘status’ command is given.

P116: Turbine 1 Emergency Stop count (R) Number of times the emergency stop has been hit while running. This parameter is only updated after a ‘status’ command is given.

P117: Turbine 1 Combustor Start count (R) Number of times the combustor has been started. This parameter is only updated after a ‘status’ command is given.

P118: Turbine 1 Combustor hours (R) Number of hours the turbine has been running.

This parameter is only updated after a ‘status’ command is given.

P119: Turbine 1 CRC Errors (R) Number of received messages that have had bad CRC's.

P120: Turbine 1 Timeouts (R) Number of times a message was expected but never received.

P121: Turbine 1 Format Err (R) Number of poorly formatted errors (i.e not starting with “attn” or too short).

P122: Turbine 1 Start command (RW) The current start command (0 or 1).

P123: Turbine 1 Power command (RW) The turbine's power command. Is immediately overwritten if P18=0.

P124: Turbine 1's highest priority fault number (R) This parameter contains the highest priority fault presently active. It is zero if the system is okay.

P125: Turbine 1 State (R) The turbine's state, wherein 0=Power up; 1=Stand by; 2=Prepart to start; 3=Bearing liftoff; 4=Open light; 5=Closed Acceleration; 6=Run; 7=Load; 8=Recharge; 9=Cooldown; 10=Warmdown; 11=Restart; 12=Shutdown; 13=Fault.

P126: Turbine 1 Voltage derivative (R).

P127: Number of error points for Turbine 1 (R).

P128: Low pass filtered voltage for turbine 1 (R).

P130: Turbine 2 Voltage (R) Turbine 1 bus voltage.

P131: Turbine 2 Power (RS) Delivered power in Watts, positive means generated power.

P132: Turbine 2 RPM (R) RPM divided by 10. This parameter is only updated after a ‘status’ command is given.

P133: Turbine 2 Average Temp (R) Average inlet and exhaust temperature. This parameter is only updated after a ‘status’ command is given.

P134: Turbine 2 Power Supply (R) Board supply is measured and expressed in 10 mV units, thus 12.54V=1254. This parameter is only updated after a ‘status’ command is given.

P135: Turbine 2 Liftoffs (R) Number of times the turbine air bearing has lifted off. This parameter is only updated after a ‘status’ command is given.

P136: Turbine 2 Emergency Stop count (R) Number of times the emergency stop has been hit while running. This parameter is only updated after a ‘status’ command is given.

P137: Turbine 2 Combustor Start count (R) Number of times the combustor has been started. This parameter is only updated after a ‘status’ command is given.

P138: Turbine 2 Combustor hours (R) Number of hours the turbine has been running.

This parameter is only updated after a ‘status’ command is given.

P139: Turbine 2 CRC Errors (R) Number of received messages that have had bad CRC's.

P140: Turbine 2 Timeouts (R) Number of times a message was expected but never received.

P141: Turbine 2 Format Err (R) Number of poorly formatted errors (i.e not starting with “attn” or too short).

P142: Turbine 2 Start command (RW) The current start command (0 or 1).

P143: Turbine 2 Power command (RW) The turbine's power command. Is immediately overwritten if P18=0.

P144: Turbine 2's highest priority fault number (R) This parameter contains the highest priority fault presently active. It is zero if the system is okay.

P145: Turbine 2 State (R) The turbine's state, wherein 0=Power up; 1=Stand by; 2=Prepart to start; 3=Bearing liftoff; 4=Open light; 5=Closed Acceleration; 6=Run; 7=Load; 8=Recharge; 9=Cooldown; 10=Warmdown; 11=Restart; 12=Shutdown; 13=Fault.

P146: Turbine 2 Voltage derivative (R).

P147: Number of error points for Turbine 2 (R).

P148: Low pass filtered voltage for turbine 2 (R).

### Description of the Low Voltage Alarm System

The bus voltage is continuously monitored and sent through a low pass filter (P39 sets the value). When this filter drops below a certain limit (P46), the difference between P46 and the filtered voltage is multiplied by a gain factor (P47) and added to a running total (P108). When P108 exceeds a certain limit, P44, the alarm comes on. The alarm goes off when P108 is less than P45. If P108 ever exceeds P48, the alarm is latched, and the vehicle will shut down after the timeout happens.

### End Appendix A

What is claimed is:

1. A steerable vehicle including a drive train that is used to propel the steerable vehicle, the steerable vehicle comprising:
a plurality of auxiliary power units operatively isolated from the drive train, wherein each auxiliary power unit generates electric energy and each auxiliary power unit has an associated efficiency profile;
an electric motor electrically coupled to the auxiliary power units and mechanically coupled to the drive train to propel the vehicle; and
a power controller communicably coupled to the plurality of auxiliary power units, to the electric motor, and to other operational aspects of the vehicle to monitor the statuses of the plurality of auxiliary power units, of the electric motor, and of other operational aspects of the vehicle;
wherein the power controller determines, based upon the monitored statuses, when to activate one or more of the plurality of auxiliary power units to provide power to the electric motor; and
wherein the power controller determines which of the plurality of auxiliary power units to activate by referencing the efficiency profiles.

2. The steerable vehicle of claim 1, wherein at least one of the auxiliary power units comprises
an engine; and
a generator mechanically coupled to the engine.

3. The steerable vehicle of claim 1, wherein at least one of the auxiliary power units comprises a turbine.

4. The steerable vehicle of claim 1, wherein at least one of the auxiliary power units comprises a fuel cell.

5. The steerable vehicle of claim 1, wherein the other operational aspects include an accelerator position, a braking pressure, a steering direction, a fuel level, a fuel flow, and an accessory power requirement.

6. The steerable vehicle of claim 1 further comprising an energy storage subsystem electrically coupled to the plurality of auxiliary power units and to the electric motor.

7. The steerable vehicle of claim 6, wherein the energy storage subsystem is charged by operating at least one auxiliary power unit of the plurality of auxiliary power units.

8. The steerable vehicle of claim 6, wherein the energy storage subsystem comprises at least one battery.

9. The steerable vehicle of claim 6, wherein the energy storage subsystem comprises at least one ultra-capacitor.

10. The steerable vehicle of claim 1, wherein each efficiency profile is predetermined to maximize fuel economy of each auxiliary power unit and to minimize polluting exhaust emissions of each auxiliary power unit.

11. The steerable vehicle of claim 1, wherein a first auxiliary power unit is associated with a first efficiency profile and a second auxiliary power unit is associated with a second efficiency profile, the second efficiency profile being different than the first efficiency profile.

12. A steerable vehicle including a drive train that is used to propel the steerable vehicle, the steerable vehicle comprising:
a plurality of auxiliary power units operatively isolated from the drive train, wherein each auxiliary power unit generates electric energy and each auxiliary power unit has an associated efficiency profile;
an electric motor electrically coupled to the plurality of auxiliary power units and mechanically coupled to the drive train to propel the vehicle;
an energy storage subsystem electrically coupled to the plurality of auxiliary power units and to the electric motor; and
a power controller communicably coupled to the plurality of auxiliary power units, to the energy storage subsystem, to the electric motor, and to other operational aspects of the vehicle to monitor the statuses of the plurality of auxiliary power units, of the energy storage subsystem, of the electric motor, and of other operational aspects of the vehicle;
wherein the power controller determines, based upon the monitored statuses, when to power the electric motor from the energy storage subsystem, from one or more of the plurality of auxiliary power units, or from a combination thereof; and
wherein when the electric motor is powered from the one or more of the plurality of auxiliary power units, the power controller determines which of the plurality of auxiliary power units to activate by referencing the efficiency profiles.

13. The steerable vehicle of claim 12, wherein at least one of the auxiliary power units comprises
an engine; and
a generator mechanically coupled to the engine.

14. The steerable vehicle of claim 12, wherein at least one of the auxiliary power units comprises a turbine.

15. The steerable vehicle of claim 12, wherein at least one of the auxiliary power units comprises a fuel cell.

16. The steerable vehicle of claim 12, wherein the other operational aspects include an accelerator position, a braking pressure, a steering direction, a fuel level, a fuel flow, and an accessory power requirement.

17. The steerable vehicle of claim 12, wherein the energy storage subsystem is charged by operating at least one auxiliary power unit of the plurality of auxiliary power units.

18. The steerable vehicle of claiml2, wherein the energy storage subsystem comprises at least one battery.

19. The steerable vehicle of claim 12, wherein the energy storage subsystem comprises at least one ultra-capacitor.

20. The steerable vehicle of claim 12, wherein a first auxiliary power unit is associated with a first efficiency profile and a second auxiliary power unit is associated with a second efficiency profile, the second efficiency profile being different than the first efficiency profile.

21. In a hybrid vehicle having a drive train that is used to propel the vehicle, an electric motor mechanically coupled to the drive train to propel the vehicle, a plurality of auxiliary power units electrically coupled to the electric motor, andan energy storage subsystem electrically coupled tothe electric motor and to the auxiliary power units, a power controller comprising:
a processor;
a memory communicably coupled to the processor; and
one or more electronic interfaces communicably coupled to the processor, the electronic interfaces permitting the processor to monitor the statuses of the plurality of auxiliary power units, of the energy storage subsystem, of the electric motor, and of other operational aspects of the vehicle;
wherein the processor determines, based upon the monitored statuses, when to power the electric motor from the energy storage subsystem, from one or more of the plurality of auxiliary power units, or from a combination thereof; and
wherein when the power controller powers the electric motor from the one or more of the plurality of auxiliary power units, the processor determines which of the plurality of auxiliary power units to utilize by referencing a plurality of efficiency profiles, the plurality of efficiency profiles being stored in the memory and each efficiency profile being associated with one of the auxiliary power units.

22. The power controller of claim 21, wherein the other operational aspects include an accelerator position, a braking pressure, a steering direction, a fuel level, a fuel flow, and an accessory power requirement.

23. In a hybrid vehicle having a drive train that is used to propel the vehicle, an electric motor mechanically coupled to the drive train to propel the vehicle, a plurality of auxiliary power units electrically coupled to the electric motor, and an energy storage subsystem electrically coupled to the electric motor and to the auxiliary power units, a method of controlling the electric energy supplied to the electric motor comprising:
continually monitoring statuses of the plurality of auxiliary power units, of the energy storage subsystem, of the electric motor, and of other operational aspects of the vehicle to determine power requirements of the vehicle;
activating one or more of the plurality of auxiliary power units to provide power to the electric motor based upon the monitored statuses and the power requirements, wherein when power is provided to the electric motor from the one or more of the plurality of auxiliary power units, the one or more of the plurality of auxiliary power units that is activated is determined by referencing a plurality of efficiency profiles, each efficiency profile being associated with one of the auxiliary power units.

24. The method of claim 23, wherein activating one or more of the plurality of auxiliary power units includes identifying a first auxiliary power unit among the plurality of auxiliary power units that has an power output meeting or exceeding the power requirements when the first auxiliary power unit is operated within a range of efficiency as identified by the efficiency profile associated with the first auxiliary power unit.

25. The method of claim 23 further comprising deactivating one or more of the activated auxiliary power units as the power requirements of the vehicle decrease.

26. The method of claim 23 further comprising predetermining the plurality of efficiency profiles prior to monitoring the statuses.

27. The method of claim 23 further comprising storing power in the energy storage subsystem after activating the one or more of the plurality of auxiliary power units.

28. The method of claim 23, wherein the other operational aspects include an accelerator position, a braking pressure, a steering direction, a fuel level, a fuel flow, and an accessory power requirement.
